(19) United States
(12) Patent Application Publication
(10) Pub. No.: US 2026/0043914 A1
(43) Pub. Date: Feb. 12, 2026

(54) ELECTRONIC DEVICE COMPRISING ANTENNA

(71) Applicant: Samsung Electronics Co., Ltd., Suwon-si (KR)

(72) Inventors: Sukgi HONG, Suwon-si (KR); Seungshik SHIN, Suwon-si (KR); Sumin YUN, Suwon-si (KR); Hyeoksoo LIM, Suwon-si (KR); Woosik CHO, Suwon-si (KR); Sehwan CHOI, Suwon-si (KR)

(21) Appl. No.: 19/363,163

(22) Filed: Oct. 20, 2025

Related U.S. Application Data
(63) Continuation of application No. PCT/KR2024/002874, filed on Mar. 6, 2024.

(30) Foreign Application Priority Data
May 23, 2023 (KR) 10-2023-0066232
Jun. 27, 2023 (KR) 10-2023-0082325

(51) Int. Cl. G01S 13/76; G01S 13/02; H01Q 1/24; H01Q 9/04; H01Q 9/30; H04M 1/02

(52) U.S. Cl. CPC G01S 13/765; G01S 13/0209; H01Q 1/242; H01Q 9/0421; H01Q 9/30; H04M 1/0266

(57) ABSTRACT

An electronic device is provided. The electronic device includes a side member including a first side surface having formed thereon a first segment portion and a second side surface having formed thereon a second segment portion, a first antenna including a first conductive portion at least partially included on the first side surface, a second antenna including a second conductive portion at least partially included on the second side surface, a printed circuit board disposed inside the side member and including at least one processor and a wireless communication module, a third antenna disposed between the first antenna and the second antenna, and memory, including one or more storage media, storing instructions, wherein the at least one processor is communicatively coupled to the memory and the wireless communication module, wherein the first antenna and the second antenna are antennas of a first type and the third antenna is an antenna of a second type, and wherein the instructions when executed by the at least one processor individually or collectively, cause the electronic device to receive a first phase signal from an external electronic device by using the first antenna and the third antenna, receive a second phase signal from the external electronic device by using the first antenna and the second antenna, and, based on the first phase signal and the second phase signal, identify a position of the external electronic device.

### CROSS-REFERENCE TO RELATED APPLICATION(S)

This application is a continuation application, claiming priority under 35 U.S.C. § 365(c), of an International application No. PCT/KR2024/002874, filed on Mar. 6, 2024, which is based on and claims the benefit of a Korean patent application number 10-2023-0066232, filed on May 23, 2023, in the Korean Intellectual Property Office, and of a Korean patent application number 10-2023-0082325, filed on Jun. 27, 2023, in the Korean Intellectual Property Office, the disclosure of each of which is incorporated by reference herein in its entirety.

### BACKGROUND

### 1. Field

The disclosure relates to an electronic device including at least one antenna.

### 2. Description of Related Art

The use of an electronic device, such as a bar type, a foldable type, a rollable type, or a sliding type has been increasing, and various functions have been provided to the electronic device.

The electronic device may transmit and receive phone calls and various types of data to and from an external electronic device (e.g., another electronic device) via wireless communication.

The electronic device may include at least one antenna to perform wireless communication with the external electronic device by using a network.

The above information is presented as background information only to assist with an understanding of the disclosure. No determination has been made, and no assertion is made, as to whether any of the above might be applicable as prior art with regard to the disclosure.

### SUMMARY

An electronic device may provide an angle of arrival (AoA) service capable of measuring the position of an external electronic device by using ultra-wideband (UWB) communication.

The electronic device may include a first patch antenna, a second patch antenna, and a third patch antenna. For example, the first patch antenna, the second patch antenna, and the third patch antenna may measure the angle of arrival (AoA) of a signal output from an external electronic device (e.g., another electronic device). For example, the electronic device may scan the direction of the external electronic device based on the arrangement of the first patch antenna, the second patch antenna, and the third patch antenna.

When the electronic device measures the angle of arrival (AoA) of the external electronic device by using the three patch antennas (e.g., the first patch antenna, the second patch antenna, and the third patch antenna), the space available within the electronic device for arranging various electronic components may be reduced.

Aspects of the disclosure are to address at least the above-mentioned problems and/or disadvantages and to provide at least the advantages described below. Accordingly, an aspect of the disclosure is to provide an electronic device capable of measuring the angle of arrival (AoA) of a signal received from an external electronic device by using one patch antenna and at least one antenna (e.g., a metal antenna) including a conductive portion included in a housing (e.g., a side member) of the electronic device.

Another aspect of the disclosure is to provide an electronic device capable of transmitting and/or receiving, for example, a polarized signal (e.g., a horizontally polarized wave), by using one patch antenna (e.g., an antenna of a second type) and at least one antenna (e.g., an antenna of a first type) including a conductive portion included in a housing of the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a side member including a first side surface having a first segment and a second side surface having a second segment, a first antenna including a first conductive portion at least partially included in the first side surface, a second antenna including a second conductive portion at least partially included in the second side surface, a printed circuit board disposed inside the side member and including at least one processor and a wireless communication module, a third antenna disposed between the first antenna and the second antenna, and memory, including one or more storage media, storing instructions, wherein the at least one processor is communicatively coupled to the memory and the wireless communication module, wherein the first antenna and the second antenna are antennas of a first type, and the third antenna is an antenna of a second type, wherein the instructions when executed by the at least one processor individually or collectively, cause the electronic device to receive a first phase signal from an external electronic device by using the first antenna and the third antenna, receive a second phase signal from the external electronic device by using the first antenna and the second antenna, and, based on the first phase signal and the second phase signal, identify a position of the external electronic device.

According to various embodiments of the disclosure, the angle of arrival (AoA) of a signal received from an external electronic device is accurately measured using the one patch antenna, the first antenna including the first conductive portion, and/or the second antenna including the second conductive portion, and the number of patch antennas (e.g., chip antennas) is reduced, thereby securing an arrangement space for various electronic components within the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a perspective view of a front surface of an electronic device according to an embodiment of the disclosure;

FIG. 2B is a perspective view of a rear surface of an electronic device according to an embodiment of the disclosure;

FIG. 3 is an exploded isometric view of an electronic device according to an embodiment of the disclosure;

FIG. 4A schematically illustrates a configuration of an electronic device including at least one antenna according to an embodiment of the disclosure;

FIG. 4B schematically illustrates a circuit configuration illustrating operation of an electronic device illustrated in FIG. 4A according to an embodiment of the disclosure;

FIG. 5 schematically illustrates an arrangement structure of a first antenna, a third antenna, and a second antenna of an electronic device according to an embodiment of the disclosure;

FIG. 6 schematically illustrates results of measuring an angle of arrival and phase difference of arrival of a radio wave of an electronic device disclosed in FIG. 5 according to an embodiment of the disclosure;

FIG. 7 schematically illustrates a phase difference of arrival between a first antenna, a third antenna, and a second antenna of an electronic device disclosed in FIG. 5 according to an embodiment of the disclosure;

FIG. 8 schematically illustrates an arrangement structure of a first antenna, a third antenna, and a second antenna of an electronic device according to an embodiment of the disclosure;

FIG. 9 schematically illustrates a result of measuring a phase difference of arrival of an electronic device disclosed in FIG. 8 according to an embodiment of the disclosure; and

FIG. 10 is a flowchart illustrating a method for controlling an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

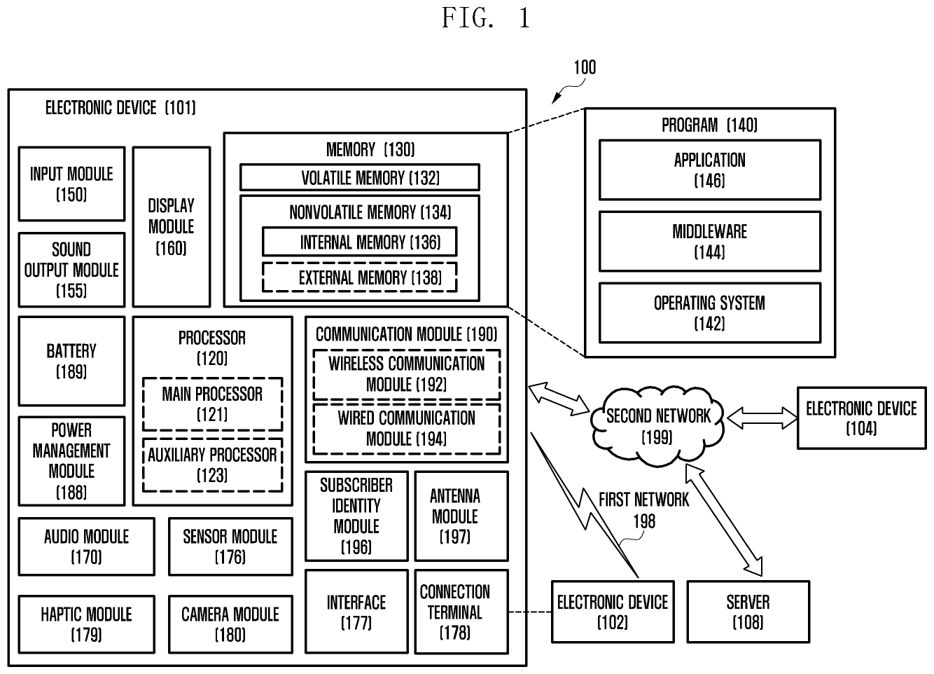

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC)..

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

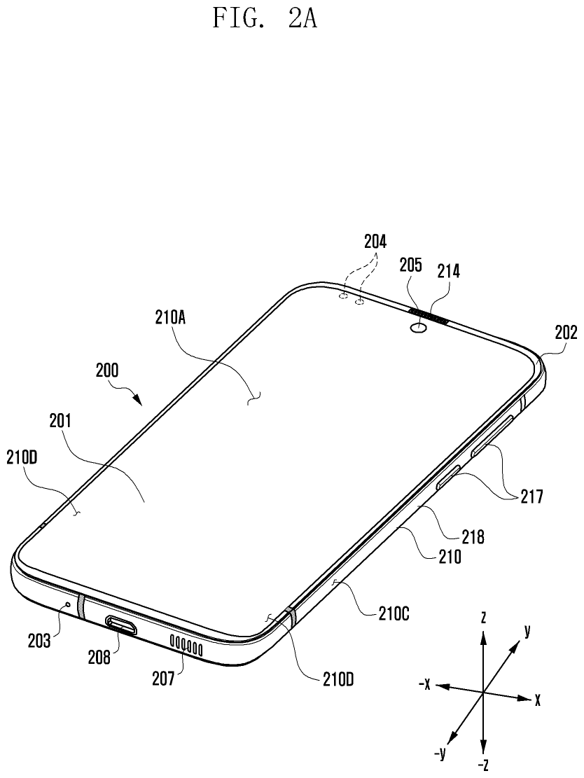

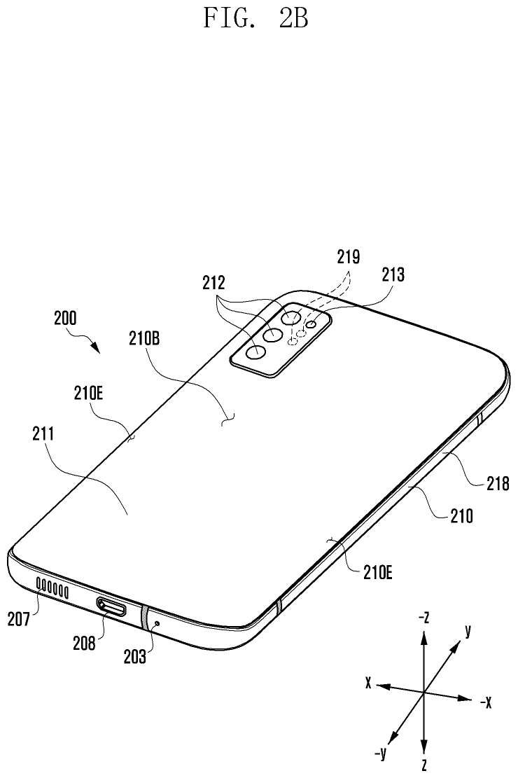

FIG. 2A is a front perspective view of an electronic device according to an embodiment of the disclosure. FIG. 2B is a rear perspective view of an electronic device in FIG. 2A according to an embodiment of the disclosure.

Referring to FIGS. 2A and 2B, an electronic device 200 according to an embodiment may include a housing 210 including a first surface (or front surface) 210A, a second surface (or rear surface) 210B, and a side surface 210C surrounding the space between the first surface 210A and the second surface 210B. In another embodiment (not illustrated), the housing may denote a structure that forms a part of the first surface 210A, the second surface 210B, and the side surface 210C illustrated in FIGS. 2A and 2B. According to an embodiment of the disclosure, the first surface 210A may be formed by a front plate 202, at least a part of which is substantially transparent (for example, a glass plate including various coating layers, or a polymer plate). The second surface 210B may be formed by a rear plate 211 that is substantially opaque. The rear plate 211 may be made of coated or colored glass, ceramic, polymer, metal (for example, aluminum, stainless steel (STS), or magnesium), or a combination of at least two of the above-mentioned materials. The side surface 210C may be formed by a side bezel structure (or “side member”) 218 which is coupled to the front plate 202 and to the rear plate 211, and which includes metal and/or polymer. In some embodiments of the disclosure, the rear plate 211 and the side bezel structure 218 may be formed integrally and may include the same material (for example, a metal material, such as aluminum).

In the illustrated embodiment of the disclosure, the front plate 202 may include two first areas 210D on both ends of the long edge of the front plate 202 such that the two first areas 210D bend from the first surface 210A toward the rear plate 211 and extend seamlessly. In the illustrated embodiment (see FIG. 2B), the rear plate 211 may include two second areas 210E on both ends of the long edge such that the two second areas 210E bend from the second surface 210B toward the front plate 202 and extend seamlessly. In some embodiments of the disclosure, the front plate 202 (or the rear plate 211) may include only one of the first areas 210D (or the second areas 210E). In another embodiment of the disclosure, a part of the first areas 210D or the second areas 210E may not be included. In the above embodiments of the disclosure, when seen from the side surface of the electronic device 200, the side bezel structure 218 may have a first thickness (or width) on a part of the side surface, which does not include the first areas 210D or the second areas 210E as described above, and may have a second thickness that is smaller than the first thickness on a part of the side surface, which includes the first areas 210D or the second areas 210E.

According to an embodiment of the disclosure, the electronic device 200 may include at least one of a display 201, audio modules 203, 207, and 214, sensor modules 204, 216, and 219, camera modules 205, 212, and 313, a key input device 217, a light-emitting element 206, and connector holes 208 and 209. In some embodiments of the disclosure, at least one of the constituent elements (for example, the key input device 217 or the light-emitting element 206) of the electronic device 200 may be omitted, or the electronic device 200 may additionally include another constituent element.

The display 201 may be exposed through a corresponding part of the front plate 202, for example. In some embodiments of the disclosure, at least a part of the display 201 may be exposed through the front plate 202 that forms the first areas 210D of the side surface 210C and the first surface 210A. In some embodiments of the disclosure, the display 201 may have a corner formed in substantially the same shape as that of the adjacent outer periphery of the front plate 202. In another embodiment (not illustrated), in order to increase the area of exposure of the display 201, the interval between the outer periphery of the display 201 and the outer periphery of the front plate 202 may be formed to be substantially identical.

The input module 203 may include a microphone. The input module 203 may include a plurality of microphones arranged therein such that the direction of a sound can be detected in some embodiments. The sound output modules 207 and 214 may include an speakers 207 and 214. In some embodiments of the disclosure, the speakers 207 and 214 and the microphone 203 may be implemented as a single hole, or a speaker may be included (for example, a piezoelectric speaker) without the speakers 207 and 214.

The sensor modules 204 and 219 may generate an electric signal or a data value corresponding to the internal operating condition of the electronic device 200 or the external environment condition thereof. The sensor modules 204 and 219 may include, for example, a first sensor module 204 (for example, a proximity sensor) arranged on the first surface 210A of the housing 210, and/or a second sensor module (not illustrated) (for example, a fingerprint sensor), and/or a third sensor module 219 (for example, a heart rate monitor (HRM) sensor) arranged on the second surface 210B of the housing 210, and/or a fourth sensor module (for example, a fingerprint sensor). The fingerprint sensor may be arranged not only on the first surface 210A (for example, the display 201) of the housing 210, but also on the second surface 210B thereof. The electronic device 200 may further include a sensor module not illustrated, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or a luminance sensor.

The camera modules 205, 212, and 213 may include a first camera device 205 arranged on the first surface 210A of the electronic device 200, a second camera device 212 arranged on the second surface 210B thereof, and/or a flash 213. The camera devices 205 and 212 may include a single lens or a plurality of lenses, an image sensor, and/or an image signal processor. The flash 213 may include, for example, a light-emitting diode (LED) or a xenon lamp. In some embodiments of the disclosure, two or more lenses (an infrared camera, a wide-angle lens, and a telephoto lens) and image sensors may be arranged on a single surface of the electronic device 200.

The key input device 217 may be arranged on the side surface 210C of the housing 210. In another embodiment of the disclosure, the electronic device 200 may not include a part of the above-mentioned key input device 217 or the entire key input device 217, and the key input device 217 (not included) may be implemented in another type, such as a soft key, on the display 201. In some embodiments of the disclosure, the key input device may include a sensor module 216 arranged on the second surface 210B of the housing 210.

The indicator may be disposed, for example, on the first surface 210A of the housing 210. The indicator may provide, for example, the state information of the electronic device 200 in an optical form. In an embodiment of the disclosure, the light-emitting element may provide, for example, a light source that operates in conjunction with the operation of the camera module 205. The indicator may include, for example, an LED, an IR LED, and a xenon lamp.

The connector hole 208 may include a first connector hole 208 capable of accommodating a connector (e.g., a USB connector) configured to transmit/receive power and/or data to/from an external electronic device, and a second connector hole (e.g., an earphone jack) capable of accommodating a connector configured to transmit/receive an audio signal to/from an external electronic device.

Some camera modules 205 among the camera modules 205 and 212, some sensor modules 204 among the sensor modules 204 and 219, or the indicator may be disposed to be exposed through the display 201. For example, the camera module 205, the sensor module 204, or the indicator may be arranged in the internal space in the electronic device 200 to be in contact with the external environment through a through hole perforated in the display 201 up to the front plate 202. In an embodiment of the disclosure, some sensor module 204 may be disposed to execute their functions in the internal space of the electronic device 200 without being visually exposed through the front surface plate 202. For example, in this case, the area of the display 201 facing the sensor module may not require a through hole.

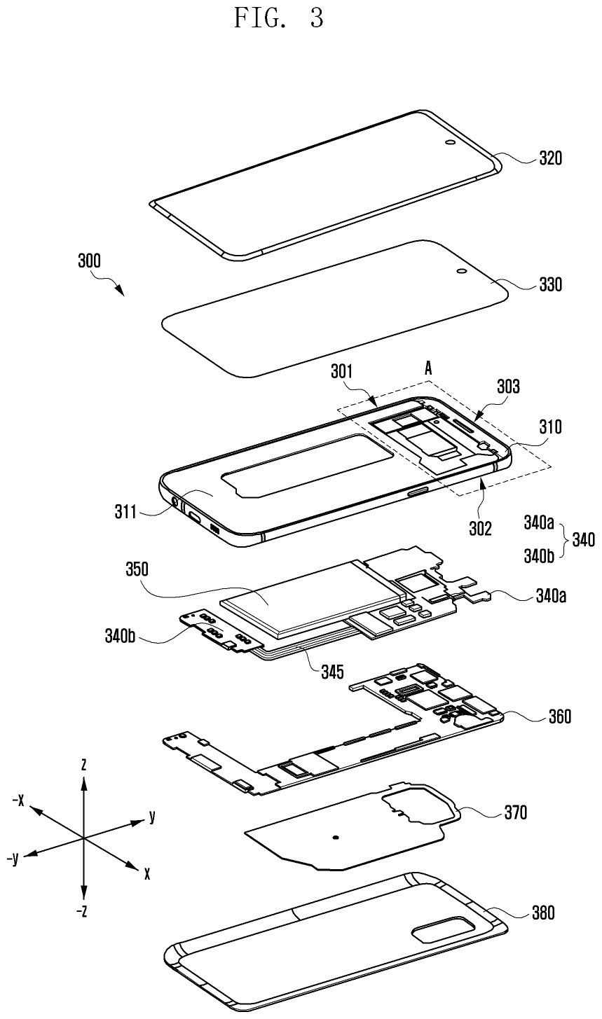

FIG. 3 is an exploded perspective view of an electronic device according to an embodiment of the disclosure.

Referring to FIG. 3, according to one embodiment of the disclosure, the electronic device 300 of FIG. 3 may include the electronic device 101 of FIG. 1, the electronic device 200 of FIGS. 2A and/or 2B. According to various embodiments of the disclosure, the electronic device 300 of FIG. 3 may include at least some similar or different embodiments from the electronic device 101 of FIG. 1, the electronic device 200 of FIGS. 2A and/or 2B.

Referring to FIG. 3, the electronic device 300 may include a side bezel structure 310, a first support member 311 (for example, a bracket), a front plate 320, a display 330, a printed circuit board 340, a battery 350, a second support member 360 (for example, a rear case), an antenna 370, and a rear plate 380. In some embodiments of the disclosure, at least one of the constituent elements (for example, the first support member 311 or the second support member 360) of the electronic device 300 may be omitted, or the electronic device 300 may further include another constituent element. At least one of the constituent elements of the electronic device 300 may be identical or similar to at least one of the constituent elements of the electronic device 101 or 200 of FIGS. 1, 2A, and 2B, and repeated descriptions thereof will be omitted herein.

The first support member 311 may be arranged inside the electronic device 300 and connected to the side bezel structure 310, or may be formed integrally with the side bezel structure 310. The first support member 311 may be made of a metal material and/or a nonmetal (for example, polymer) material, for example. The display 330 may be coupled to one surface of the first support member 311, and the printed circuit board 340 may be coupled to the other surface thereof.

For example, the printed circuit board 340 may include the processor 120, memory 130 and/or interface 177 disposed in the FIG. 1. For example, the processor may include one or more of a central processing unit, an application processor, a graphic processing unit, an image signal processor, a sensor hub processor, or a communication processor.

According to an embodiment of the disclosure, the printed circuit board 340 may include a first PCB 340a and/or a second PCB 340b. For example, the first PCB 340a and the second PCB 340b may be arranged to be spaced apart from each other and may be electrically connected using a connecting member 345 (e.g., a coaxial cable and/or an FPCB). In an embodiment of the disclosure, the printed circuit board 340 may include a structure in which multiple printed circuit boards (PCBs) are stacked. For example, the printed circuit board 340 may include an interposer structure. In an embodiment of the disclosure, the printed circuit board 340 may be implemented in the form of a flexible printed circuit board (FPCB) and/or a rigid printed circuit board (rigid PCB).

According to various embodiments of the disclosure, the printed circuit board 340 may include the wireless communication module 192 electrically connected to the processor 120.

According to various embodiments of the disclosure, the side member 310 (e.g., the housing 210 in FIG. 2A and/or FIG. 2B) may include at least one conductive portion separated by at least one segment. In an embodiment of the disclosure, the at least one conductive portion may be electrically connected to the wireless communication module 192 and may function as at least one antenna. According to an embodiment of the disclosure, the side member 310 (e.g., the housing) may include a first side surface 301 positioned in the −x-axis direction, a second side surface 302 positioned in the x-axis direction opposite the first side surface 301, and a third side surface 303 positioned in the y-axis direction between the first side surface 301 and the second side surface 302.

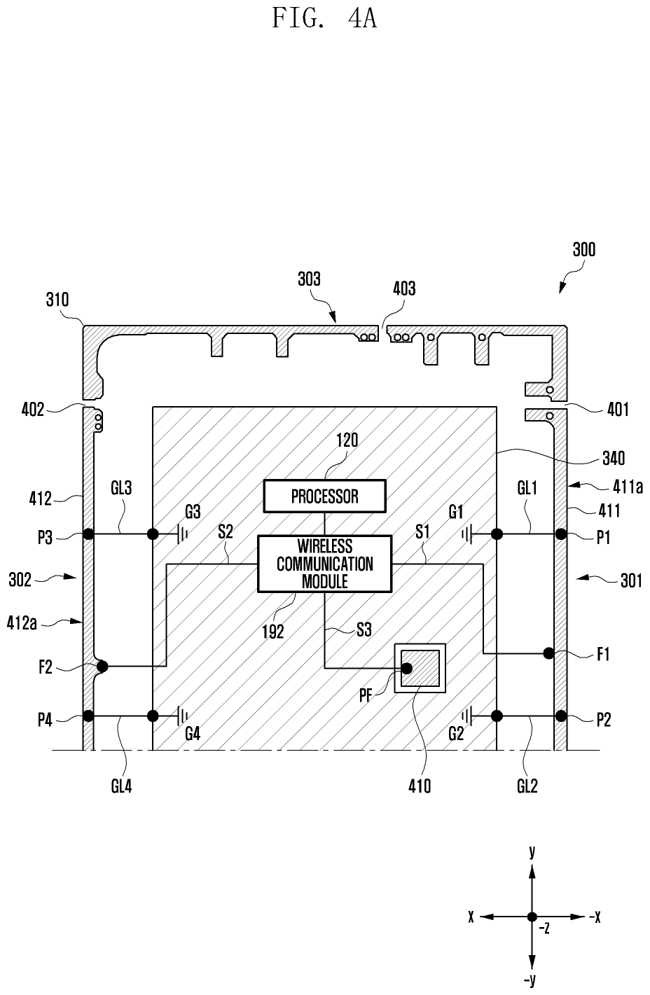

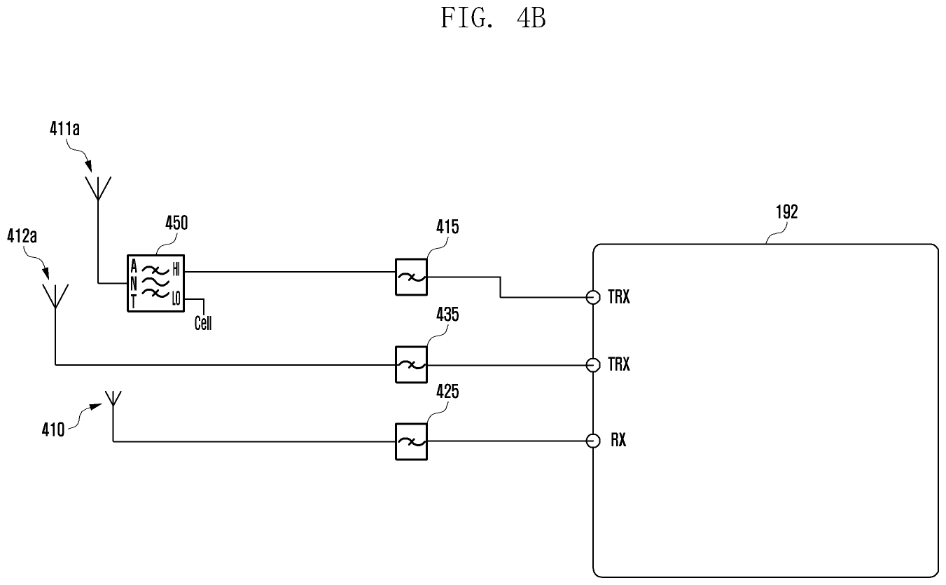

According to various embodiments of the disclosure, a patch antenna (e.g., the third antenna 410 in FIG. 4A) may be disposed on the printed circuit board 340 in the −z-axis direction. For example, the patch antenna (e.g., the third antenna 410 in FIG. 4A) may be disposed on an antenna structure (e.g., the antenna module 197 in FIG. 1) that includes a ground on one surface thereof. For example, the patch antenna (e.g., the third antenna 410 in FIG. 4A) may be disposed between the first support member 311 and the rear plate 380. For example, the patch antenna (e.g., the third antenna 410 in FIG. 4A) may be disposed inside the side member 310. The patch antenna (e.g., the third antenna 410 in FIG. 4A) may be electrically connected to the wireless communication module 192 disposed on the printed circuit board 340.

The memory may include volatile memory or non-volatile memory, for example.

The interface may include, for example, a high definition multimedia interface (HDMI), a universal serial bus (USB) interface, an SD card interface, and/or an audio interface. The interface may connect the electronic device 300 with an external electronic device electrically or physically, for example, and may include a USB connector, an SD card/MMC connector, or an audio connector.

The battery 350 is a device for supplying power to at least one constituent element of the electronic device 300, and may include a non-rechargeable primary cell, a rechargeable secondary cell, or a fuel cell, for example. At least a part of the battery 350 may be arranged on substantially the same plane with the printed circuit board 340, for example. The battery 350 may be arranged integrally inside the electronic device 300, or may be arranged such that the same can be attached to/detached from the electronic device 300.

The antenna 370 may be arranged between the rear plate 380 and the battery 350. The antenna 370 may include, for example, a near field communication (NFC) antenna, a wireless charging antenna, and/or a magnetic secure transmission (MST) antenna. The antenna 370 may conduct near-field communication with an external device or may wirelessly transmit/receive power necessary for charging, for example. In another embodiment of the disclosure, an antenna structure may be formed by a part or a combination of the side bezel structure 310 and/or the first support member 311.

According to various embodiments of the disclosure, the electronic device 300 disclosed below may include at least some of the embodiments of the electronic devices 101, 200, and 300 disclosed in FIGS. 1, 2A, 2B, and 3. In the description of the electronic device 300 disclosed below, components substantially identical to those disclosed in the embodiments of FIGS. 1, 2A, 2B, and 3 may be assigned the same reference numerals, and redundant descriptions of functions thereof may be omitted.

According to an embodiment of the disclosure, the embodiments related to the electronic device 300 disclosed below describe a bar-type electronic device, but are not limited thereto and may also be applied to electronic devices, such as foldable types, rollable types, sliding types, wearable types, tablet PCs, and/or notebook PCs.

FIG. 4A schematically illustrates a configuration of an electronic device including at least one antenna according to an embodiment of the disclosure.

In an embodiment of the disclosure, FIG. 4A may a view schematically illustrating a portion (e.g., portion A in FIG. 3) of the electronic device 300, viewed from the −z-axis direction, in a state in which the printed circuit board 340 (e.g., the first PCB 340a) is disposed on one surface (e.g., the −z axis direction) of the first support member 311 of the side member 310 (e.g., the housing) disclosed in FIG. 3 according to various embodiments of the disclosure.

Referring to FIG. 4A, the electronic device 300 may include a printed circuit board 340, a processor 120, a wireless communication module 192, a first antenna 411a, a second antenna 412a, and/or a third antenna 410.

According to an embodiment of the disclosure, the processor 120 and the wireless communication module 192 may be disposed on the printed circuit board 340. For example, the processor 120 may include a communication processor. For example, the wireless communication module 192 may include a radio frequency IC (RFIC) and/or an ultra-wideband (UWB) integrated circuit (IC). For example, the third antenna 410 (e.g., a patch antenna) may be disposed between the printed circuit board 340 and the rear plate 380 disclosed in FIG. 3. For example, the third antenna 410 may be disposed between the first support member 311 and the rear plate 380 disclosed in FIG. 3. For example, the third antenna 410 may include a planar antenna, such as a patch antenna.

According to an embodiment of the disclosure, the printed circuit board 340 may include a ground. The ground of the printed circuit board 340 may include at least one ground point (e.g., a first ground point G1, a second ground point G2, a third ground point G3, and/or a fourth ground point G4). The printed circuit board 340 may be disposed in the side member 310 (e.g., the housing 210 in FIGS. 2A and 2B). In an embodiment of the disclosure, the printed circuit board 340 may be at least partially spaced apart from the side member 310.

According to an embodiment of the disclosure, the side member 310 (e.g., the housing) of the electronic device 300 may include a first segment 401 and a second segment 402. For example, the first segment 401 may be formed in the first side surface 301 of the side member 310 located in the −x-axis direction. The second segment 402 may be formed in the second side surface 302 of the side member 310 located in the x-axis direction. The side member 310 may include a third side surface 303 located in the y-axis direction. A third segment 403 may be formed in the third side surface 303.

According to an embodiment of the disclosure, the first side surface 301 may include a first conductive portion 411 (e.g., a first radiator) spaced apart from the third side surface 303 by the first segment 401. In an embodiment of the disclosure, the first conductive portion 411 may include a first feed point F1, a first point P1, and a second point P2. The first conductive portion 411 may be electrically connected to the wireless communication module 192 via the first feed point F1 and a first signal path S1, and may function as the first antenna 411a. For example, the first feed point F1 may be located between the first point P1 and the second point P2. For example, the first point P1 may be located between the first segment 401 and the first feed point F1. The first point P1 may be electrically connected to the first ground point G1 of the printed circuit board 340 via a first ground path GL1. The second point P2 may be electrically connected to the second ground point G2 on the printed circuit board 340 via a second ground path GL2. The first ground point G1 and the second ground point G2 may ground the first conductive portion 411. For example, the first antenna 411a including the first conductive portion 411 may operate as a first slot antenna by using the first ground point G1, the first point P1, the second point P2, and the second ground point G2. In an embodiment of the disclosure, the first ground path GL1 and the second ground path GL2 may include a conductive connecting member (e.g., a contact pad, a coupling member, a C-clip, or a conductive foam spring). The first ground path GL1 and the second ground path GL2 may form a grounding portion that electrically connects the ground of the printed circuit board 340 to the first antenna 411a (e.g., the first conductive portion 411). The first antenna 411a may be an antenna of a first type. In an embodiment of the disclosure, the first antenna 411a may operate as an inverted-F antenna (IFA) or a monopole antenna.

According to an embodiment of the disclosure, the second side surface 302 may include a second conductive portion 412 (e.g., a second radiator) spaced apart from the third side surface 303 by the second segment 402. In an embodiment of the disclosure, the second conductive portion 412 may include a second feed point F2, a third point P3, and a fourth point P4. The second conductive portion 412 may be electrically connected to the wireless communication module 192 via the second feed point F2 and a second signal path S2, and may function as the second antenna 412a. For example, the second feed point F2 may be located between the third point P3 and the fourth point P4. For example, the third point P3 may be located between the second segment 402 and the second feed point F2. The third point P3 may be electrically connected to the third ground point G3 of the printed circuit board 340 via a third ground path GL3. The fourth point P4 may be electrically connected to the fourth ground point G4 of the printed circuit board 340 via a fourth ground path GL4. The third ground point G3 and the fourth ground point G4 may ground the second conductive portion 412. For example, the second antenna 412a including the second conductive portion 412 may operate as a second slot antenna by using the third ground point G3, the third point P3, the fourth point P4, and the fourth ground point G4. In an embodiment of the disclosure, the third ground path GL3 and the fourth ground path GL4 may include a conductive connecting member (e.g., a contact pad, a coupling member, a C-clip, or a conductive foam spring). The third ground path GL3 and the fourth ground path GL4 may form a ground portion that electrically connects the ground of the printed circuit board 340 to the second antenna 412a (e.g., the second conductive portion 412). The second antenna 412a may be an antenna of the first type substantially identical to the first antenna 411a described above. In an embodiment of the disclosure, the second antenna 412a may operate as an inverted-F antenna (IFA) or a monopole antenna.

According to an embodiment of the disclosure, the processor 120 may be electrically connected to the wireless communication module 192. The processor 120 may control the wireless communication module 192. The processor 120 may control the wireless communication module 192 to deliver a feeding signal to at least one of the first feed point F1 of the first conductive portion 411 and the second feed point F2 of the second conductive portion 412.

According to an embodiment of the disclosure, the wireless communication module 192 may be electrically connected to the first feed point F1 of the first conductive portion 411 and the second feed point F2 of the second conductive portion 412. For example, the wireless communication module 192 may be electrically connected to the first feed point F1 via the first signal path S1. For example, the wireless communication module 192 may be electrically connected to the second feed point F2 via the second signal path S2. In an embodiment of the disclosure, the wireless communication module 192 may, under the control of the processor 120, selectively transmit a feeding signal to the first feed point F1 and/or the second feed point F2.

According to various embodiments of the disclosure, at least one wireless communication module 192 may be included. For example, multiple wireless communication module 192 may be included and may be electrically connected to the first feed point F1 and the second feed point F2 as appropriate for the situation. In various embodiments of the disclosure, the wireless communication module 192 may be electrically connected to the first feed point F1 and/or the second feed point F2 by using a connection member, such as a contact pad, a coupling member, a C-clip, or a conductive foam spring. The wireless communication module 192 may support the first conductive portion 411 and/or the second conductive portion 412 to transmit and/or receive wireless signals.

According to an embodiment of the disclosure, the third antenna 410 (e.g., a patch antenna) may be disposed in the antenna module 197 disclosed in FIG. 1. The third antenna 410 may be implemented in the form of a conductive patch and/or an IC chip. For example, the third antenna 410 may be disposed such that beam pattern is formed in one direction (e.g., the −x-axis direction). The third antenna 410 may be an antenna of a second type. For example, the third antenna 410 may include a planar antenna, such as a patch antenna. The third antenna 410 (e.g., the antenna of the second type) may have characteristics different from those of the first antenna 411a and the second antenna 412a, which are antennas of the first type. For example, the third antenna 410 may be a patch antenna, while the first antenna 411a and the second antenna 412a may be metal antennas.

According to an embodiment of the disclosure, the third antenna 410 may be disposed on an antenna structure (e.g., the antenna module 197 in FIG. 1) that includes a ground on one surface thereof. For example, the third antenna 410 may be disposed between the first support member 311 and the rear plate 380 as disclosed in FIG. 3. The third antenna 410 may be disposed inside the side member 310.

According to an embodiment of the disclosure, the third antenna 410 may include a feed point PF. For example, the feed point PF may be located in the x-axis direction between the y-axis direction and the −y-axis direction of the third antenna 410. The feed point PF of the third antenna 410 may be electrically connected to the wireless communication module 192 via a third signal path S3. In an embodiment of the disclosure, the processor 120 may control the wireless communication module 192 to deliver a feeding signal to the feed point PF of the third antenna 410. The processor 120 may control the feeding signal delivered to the feed point PF of the third antenna 410 via the wireless communication module 192 and control the polarization component of a signal radiated through the third antenna 410, thereby measuring and calculating the angle of arrival (AOA) of a signal received from an external electronic device (e.g., the external electronic device 102 or 104 in FIG. 1).

According to an embodiment of the disclosure, the feed point PF of the third antenna 410 may receive a feeding signal from a wireless communication module 192 to transmit and/or receive a signal having, for example, horizontal polarization, to and/or from the first antenna 411a including the first conductive portion 411. For example, the processor 120 may control the wireless communication module 192 to deliver a feeding signal to the feed point F1 of the first antenna 411a including the first conductive portion 411 and to the feed point PF of the third antenna 410. For example, the processor 120 may control the wireless communication module 192 to deliver a feeding signal to the feed point F1 of the first antenna 411a including the first conductive portion 411 and to the feed point PF of the third antenna 410 such that the signal has horizontal polarization.

According to an embodiment of the disclosure, the processor 120 may deliver a feeding signal to the feed point PF of the third antenna 410 and the first feed point F1 of the first antenna 411a including the first conductive portion 411, and, for example, measure the angle of arrival of a horizontal polarized wave to measure the position of an external electronic device (e.g., the external electronic device 102 or104 in FIG. 1).

According to various embodiments of the disclosure, the third antenna 410 (e.g., a patch antenna) may operate as an ultra-wideband (UWB) antenna for transmitting and receiving signals in a specified frequency band (e.g., approximately 6 GHz to 11 GHz). In the described embodiment of the disclosure, the third antenna 410 was described as transmitting and/or receiving a horizontally polarized (e.g., first polarization) signal by using one feed point PF positioned in the x-axis direction. However, the third antenna 410 may also transmit and/or receive a vertically polarized (e.g., second polarization) signal in the y-axis direction, for example.

According to an embodiment of the disclosure, the first antenna 411a and the third antenna 410 may have different antenna characteristics. The second antenna 412a and the third antenna 410 may have different antenna characteristics. The first antenna 411a and the second antenna 412a may have substantially the same antenna characteristics. In an embodiment of the disclosure, the first antenna 411a and the second antenna 412a may be antennas of a first type, such as metal antennas. For example, each of the first antenna 411a and the second antenna 412a may operate as an inverted-F antenna (IFA), a monopole antenna, or a slot antenna. For example, the first antenna 411a and the second antenna 412a may have an omnidirectional antenna pattern. In an embodiment of the disclosure, the third antenna 410 may be an antenna of a second type antenna, such as a patch antenna. The third antenna 410 may include a planar antenna, such as a patch antenna. For example, the third antenna 410 (e.g., a patch antenna) may have an antenna pattern having excellent directionality.

According to an embodiment of the disclosure, the feeding directions of the first antenna 411a, the third antenna 410, and the second antenna 412a may be formed in the horizontal direction (e.g., the −x-axis direction and the x-axis direction). For example, the first antenna 411a and the third antenna 410 may have feeding directions formed in the −x-axis direction. For example, the second antenna 412a may have a feeding direction formed in the x-axis direction. When the feeding directions of the first antenna 411a, the third antenna 410, and the second antenna 412a are formed in the horizontal direction (e.g., the −x-axis direction and the x-axis direction), the angle of arrival of a polarized wave (e.g., a horizontally polarized wave) in the horizontal direction (e.g., the −x-axis direction and the x-axis direction) of the electronic device 300 may be measured.

FIG. 4B schematically illustrates a circuit configuration illustrating an operation of an electronic device disclosed in FIG. 4A according to an embodiment of the disclosure.

Referring to FIG. 4B, a diplexer 450 and a first filter 415 may be disposed between the wireless communication module 192 and the first antenna 411a. The diplexer 450 may be disposed on the printed circuit board 340. For example, the diplexer 450 may separate frequency signals outside the UWB frequency band (e.g., approximately 6 GHz to approximately 11 GHz) received via the first antenna 411a into cells and transmit only signals in the UWB frequency band to the wireless communication module 192. In an embodiment of the disclosure, the frequency signals separated into cells may be connected to other wireless communication modules and utilized for various communication services (e.g., long term evolution (LTE), mmWave, GPS, Bluetooth, or Wi-Fi communication).

According to various embodiments of the disclosure, the diplexer 450 may include a branching filter element used to combine or separate/split two signals having different frequencies on a single channel or line. For example, the diplexer 450 may be a coupler for sharing two different frequency signals. The diplexer 450 may be, for example, a coupler or filter for propagating communication signals of two different frequency bands without interference by sharing a single antenna. For example, the diplexer 450 may include a low-pass filter (LPF) and/or a high-pass filter (HPF).

According to an embodiment of the disclosure, the first filter 415 may be disposed between the diplexer 450 and the wireless communication module 192. The first filter 415 may be positioned on the printed circuit board 340. The first filter 415 may filter out frequency signals outside the UWB frequency band transmitted via the first antenna 411a and/or the diplexer 450, and may transmit only signals in the UWB frequency band to the wireless communication module 192.

According to an embodiment of the disclosure, a second filter 425 (e.g., a band-pass filter (BPF)) may be disposed between the wireless communication module 192 and the third antenna 410 (e.g., a patch antenna). For example, the second filter 425 may be disposed on the printed circuit board 340. The second filter 425 may filter out frequency signals outside the UWB frequency band received via the third antenna 410 and transmit only signals in the UWB frequency band to the wireless communication module 192.

According to an embodiment of the disclosure, a third filter 435 (e.g., a band-pass filter (BPF)) may be disposed between the wireless communication module 192 and the second antenna 412a. For example, the third filter 435 may be disposed on the printed circuit board 340. The third filter 435 may filter out frequency signals outside the UWB frequency band received via the second antenna 412a and transmit only signals in the UWB frequency band to the wireless communication module 192.

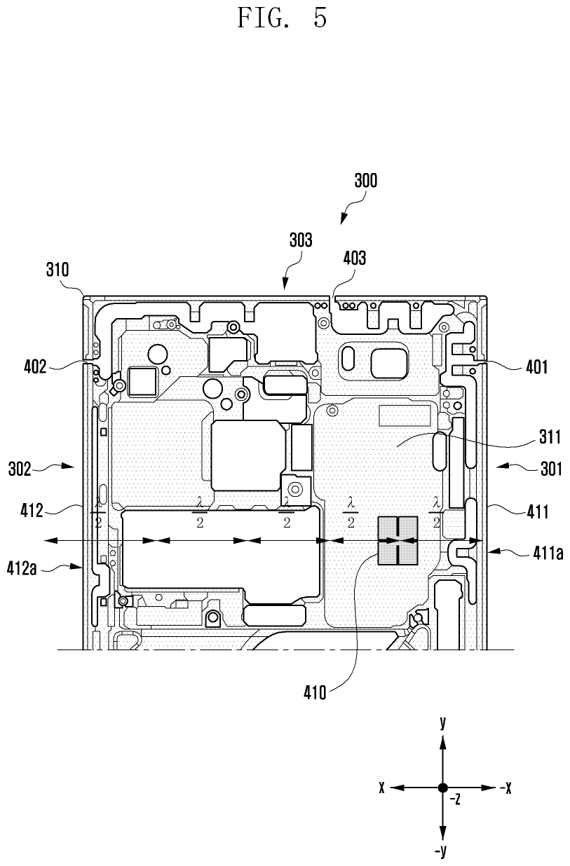

FIG. 5 schematically illustrating an arrangement structure of a first antenna, a third antenna, and a second antenna of an electronic device according to an embodiment of the disclosure.

Referring to FIG. 5, it may schematically illustrate a portion (e.g., portion A in FIG. 3) of an electronic device 300 viewed from the −z-axis direction in a state in which a third antenna 410 is disposed between the rear plate 380 and the first support member 311 of the side member 310 (e.g., the housing 210 in FIGS. 2A and 2B) disclosed in FIG. 3 according to various embodiments of the disclosure and the printed circuit board 340 is omitted.

According to various embodiments of the disclosure, the electronic device 300 disclosed below may include embodiments of the electronic device 300 disclosed in FIGS. 4A and 4B. For example, the arrangement structure of a first antenna 411a, a third antenna 410 (e.g., a patch antenna), and a second antenna 412a of the electronic device 300 disclosed in FIG. 5 may be applied to FIG. 4A. In the description of the electronic device 300 disclosed below, components substantially identical to those disclosed in the embodiment of FIG. 4A may be assigned the same reference numbers, and redundant descriptions of functions thereof may be omitted.

Referring to FIG. 5, the electronic device 300 may include a first antenna 411a, a second antenna 412a, and/or a third antenna 410.

According to an embodiment of the disclosure, a side member 310 (e.g., a housing) of the electronic device 300 may include a first segment 401 and a second segment 402. For example, the first segment 401 may be formed in a first side surface 301 of the side member 310 located in the −x-axis direction. The second segment 402 may be formed in a second side surface 302 of the side member 310 located in the x-axis direction. The side member 310 may include a third side surface 303 spaced apart from the first side surface 301 by the first segment 401 and spaced apart from the second side surface 302 by the second segment 402.

According to an embodiment of the disclosure, the first side surface 301 may be spaced apart from the third side surface 303 by the first segment 401 and may include the first antenna 411a including a first conductive portion 411.

According to an embodiment of the disclosure, the second side surface 302 is spaced apart from the third side surface 303 by the second segment 402 and may include the second antenna 412a including a second conductive portion 412.

According to an embodiment of the disclosure, the third antenna 410 (e.g., a patch antenna) may be positioned between the first antenna 411a and the second antenna 412a. For example, the first antenna 411a, the third antenna 410, and the second antenna 412a may be substantially aligned in the horizontal direction (e.g., the −x-axis direction and the x-axis direction).

According to an embodiment of the disclosure, the first antenna 411a and the third antenna 410 may have different antenna characteristics. The first antenna 411a and the second antenna 412a may have substantially the same antenna characteristics. For example, the first antenna 411a may include a conductive material (e.g., metal). The third antenna 410 may include a conductive patch antenna or a chip antenna. For example, the chip antenna may be a high-permittivity chip antenna based on low-temperature co-fired ceramic (LTCC). The second antenna 412a may include a conductive material (e.g., metal).

According to an embodiment of the disclosure, the first antenna 411a and the second antenna 412a may be antennas of a first type. The antennas of the first type may include a metal antenna. In an embodiment of the disclosure, the third antenna 410 may be an antenna of a second type. The third antenna 410 may include a planar antenna, such as a patch antenna.

According to an embodiment of the disclosure, the first antenna 411a and the third antenna 410 may be positioned within a distance of approximately λ/2 (half-wavelength). For example, the first antenna 411a and the third antenna 410 may be disposed within a distance of approximately λ/2 (half-wavelength) at the operating frequency. For example, the half-wavelength at approximately 7,987.2 MHz, which is the center frequency of the operating frequency of UWB channel 9 (e.g., 7,737 MHz to 8,236.8 MHz), may be approximately 18 mm. For example, the first antenna 411a and the third antenna 410 may be disposed within a distance of approximately λ/2 (half-wavelength) (e.g., 18 mm) and may measure the angle of arrival (AOA) of a radio wave from approximately −90 degrees to +90 degrees.

According to an embodiment of the disclosure, the first antenna 411a and the second antenna 412a may be positioned at a distance of approximately K*λ/2 (e.g., K is not an integer) or more. For example, referring to FIG. 5, the distance between the first antenna 411a and the second antenna 412a may be approximately 4.3*λ/2. For example, the first antenna 411a may be positioned closer to the third antenna 410 than to the second antenna 412a. In an embodiment of the disclosure, the distance between the first antenna 411a and the third antenna 410 may differ from the distance between the first antenna 411a and the second antenna 412a. For example, the distance between the first antenna 411a and the third antenna 410 may be shorter than the distance between the first antenna 411a and the second antenna 412a.

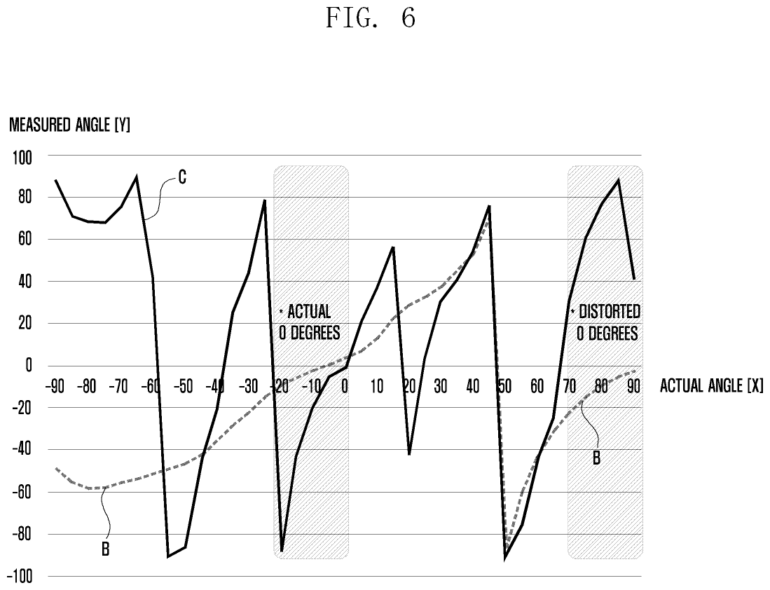

FIG. 6 schematically illustrates results of measuring an angle of arrival and phase difference of arrival of an electronic device disclosed in FIG. 5 according to an embodiment of the disclosure.

Referring to FIG. 6, the x-axis may represent the actual angle of the angle of arrival (AOA), and the y-axis may represent the measured angle of the angle of arrival (AOA). In an embodiment of the disclosure, graph B shown in FIG. 6 may be, for example, the phase difference of arrival (PDoA) measured using the first antenna 411a and the third antenna 410 (e.g., a patch antenna) disclosed in FIG. 5. In various embodiments of the disclosure, graph C shown in FIG. 6 may be, for example, the phase difference of arrival measured using the first antenna 411a and the second antenna 412a disclosed in FIG. 5.

In an embodiment of the disclosure, referring to graph B shown in FIG. 6, it can be observed that the phase difference of arrival measured using the first antenna 411a and the third antenna 410 increases sharply at approximately 50 degrees. For example, due to the characteristic difference between the first antenna 411a (e.g., an antenna of a first type) and the third antenna 410 (e.g., an antenna of a second type) , the phase difference of arrival measured using the first antenna 411a and the third antenna 410 may increase sharply at approximately 50 degrees. It can be observed that the phase difference of arrival measured using the first antenna 411a and the third antenna 410 has a distorted value of 0 degrees at approximately 80 to 90 degrees. Thus, the actual 0 degrees and the distorted 0 degrees can be observed in the phase difference of arrival using the first antenna 411a and the third antenna 410.

In various embodiments of the disclosure, referring to graph C shown in FIG. 6, it can be observed that when the separation distance between the first antenna 411a and the second antenna 412a is approximately 77 mm, which is K*(λ/2) (e.g., K is not an integer), the phase difference of arrival measured using the first antenna 411a and the second antenna 412a has a certain periodicity within a range of, for example, approximately +90 degrees to −90 degrees. For example, since the first antenna 411a and the second antenna 412a are antennas of a second type having substantially identical characteristics, such as metal antennas, there may be no portion where the phase difference of arrival changes abruptly. For example, a phase signal may be a signal having a constant periodicity. Thus, in the phase difference of arrival using the first antenna 411a and the second antenna 412a, the actual 0 degrees can be observed, and that the phase difference of arrival can be observed to be approximately +40 degrees or more at angles of approximately 70 degrees or more. In various embodiments of the disclosure, at the separation distance K*(λ/2) between the first antenna 411a and the second antenna 412a, for example, when K is an integer, if the separation distance between the first antenna 411a and the second antenna 412a is approximately 36 mm or approximately 54 mm, the first antenna 411a and the second antenna 412a may have substantially the same period, making it difficult to distinguish between the distorted 0 degrees and the actual 0 degrees. According to an embodiment of the disclosure, the first antenna 411a and the second antenna 412a have different media, thus degrading phase characteristics and causing phase deviation.

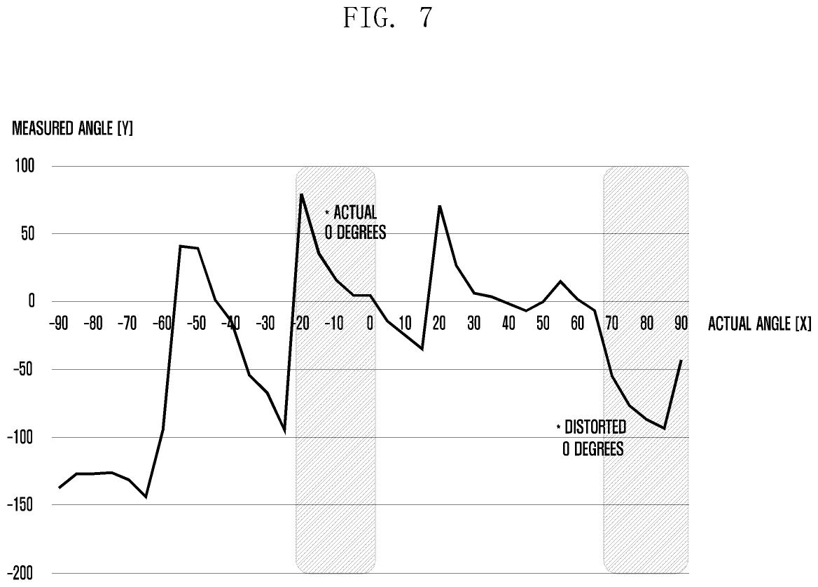

FIG. 7 schematically illustrates a phase difference of arrival between a first antenna, a third antenna, and a second antenna of an electronic device disclosed in FIG. 5 according to an embodiment of the disclosure.

For example, FIG. 7 may be a view illustrating the phase difference of arrival (PDoA) between the first antenna 411a and the third antenna 410 disclosed in FIG. 5, and the phase difference of arrival between the first antenna 411a and the second antenna 412a.

Referring to FIG. 7, the x-axis may represent the actual angle of the angle of arrival (AOA), and the y-axis may represent the measured angle of the angle of arrival (AOA).

According to an embodiment of the disclosure, the phase difference of arrival (PDoA) between the first antenna 411a and the third antenna 410, and the phase difference of arrival between the first antenna 411a and the second antenna 412a have positive values around the actual 0 degrees, and negative values around the distorted 0 degrees (e.g., approximately +70 to +90 degrees). Through this, the electronic device 300 may distinguish between the actual 0 degrees and the distorted 0 degrees.

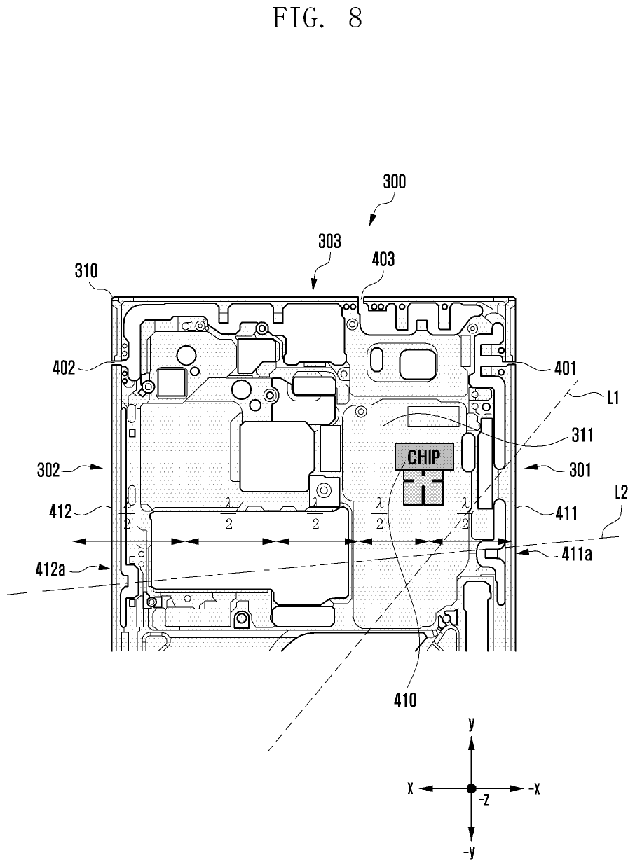

FIG. 8 schematically illustrates an arrangement structure of a first antenna, a third antenna, and a second antenna of an electronic device according to an embodiment of the disclosure.

In an embodiment of the disclosure, FIG. 8 may be a view schematically illustrating a portion (e.g., portion A in FIG. 3) of the electronic device 300 viewed from the −z axis direction in a state in which the third antenna 410 (e.g., a chip antenna) is disposed between the rear plate 380 and the first support member 311 of the side member 310 (e.g., the housing 210 in FIGS. 2A and 2B) disclosed in FIG. 3 according to various embodiments of the disclosure, and the printed circuit board 340 is omitted.

According to various embodiments of the disclosure, the electronic device 300 disclosed below may include embodiments of the electronic device 300 disclosed in FIGS. 4A and 4B. For example, the arrangement structure of a first antenna 411a, a third antenna 410, and a second antenna 412a of the electronic device 300 disclosed in FIG. 8 may be applied to FIG. 4A. In the description of the electronic device 300 disclosed below, components substantially identical to those disclosed in the embodiment of FIG. 4A may be assigned the same reference numbers, and redundant descriptions of functions thereof may be omitted.

Referring to FIG. 8, the electronic device 300 may include a first antenna 411a, a second antenna 412a, and/or a third antenna 410.

According to an embodiment of the disclosure, a side member 310 (e.g., a housing) of the electronic device 300 may include a first segment 401 and a second segment 402. For example, the first segment 401 may be formed in a first side surface 301 of the side member 310 located in the −x-axis direction. The second segment 402 may be formed in a second side surface 302 of the side member 310 located in the x-axis direction. The side member 310 may include a third side surface 303 spaced apart from the first side surface 301 by the first segment 401 and spaced apart from the second side surface 302 by the second segment 402.

According to an embodiment of the disclosure, the first side surface 301 may be spaced apart from the third side surface 303 by the first segment 401 and may include the first antenna 411a including a first conductive portion 411.

According to an embodiment of the disclosure, the second side surface 302 may be spaced apart from the third side surface 303 by the second segment 402 and may include the second antenna 412a including a second conductive portion 412.

According to an embodiment of the disclosure, the third antenna 410 (e.g., a chip antenna) may be disposed between the first antenna 411a and the second antenna 412a. For example, the third antenna 410 (e.g., a chip antenna) may be substantially misaligned with the first antenna 411a and/or the second antenna 412a in the horizontal direction (e.g., the −x-axis direction and the x-axis direction). For example, the third antenna 410 (e.g., a chip antenna) may be positioned above (e.g., in the y-axis direction) the first antenna 411a and the second antenna 412a.

According to an embodiment of the disclosure, the first antenna 411a and the third antenna 410 may have different antenna characteristics. The first antenna 411a and the second antenna 412a may have substantially the same antenna characteristics. For example, the first antenna 411a may include a conductive material (e.g., metal). The third antenna 410 may include a conductive patch and/or a chip antenna. The second antenna 412a may include a conductive material (e.g., metal).

According to an embodiment of the disclosure, the first antenna 411a and the second antenna 412a may be antennas of a first type. The antennas of the first type may include a metal antenna. In an embodiment of the disclosure, the third antenna 410 may be an antenna of a second type. The third antenna 410 may include a planar antenna, such as a patch antenna. For example, the third antenna 410 (e.g., a chip antenna) may be a high-permittivity chip antenna based on low-temperature co-fired ceramic (LTCC).

According to an embodiment of the disclosure, the first antenna 411a and the third antenna 410 (e.g., a chip antenna) may be positioned within a distance of approximately λ/2 (half-wavelength). For example, the first antenna 411a and the third antenna 410 may be disposed within a distance of approximately λ/2 (half-wavelength) at the operating frequency.

According to an embodiment of the disclosure, the first antenna 411a and the second antenna 412a may be positioned at a distance of approximately K*λ/2 (e.g., K is not an integer) or greater. For example, the first antenna 411a may be disposed closer to the third antenna 410 than to the second antenna 412a. For example, the distance between the first antenna 411a and the third antenna 410 may be shorter than the distance between the first antenna 411a and the second antenna 412a.

According to an embodiment of the disclosure, when the first antenna 411a and the third antenna 410 are misaligned, the second antenna 412a may have a different intersecting line for compensating for the misalignment between the first antenna 411a and the third antenna 410. For example, a first intersecting line L1 based on the centers of the first antenna 411a and the third antenna 410, which are misaligned with respect to the −x-axis and the x-axis, and a second intersecting line L2 based on the centers of the first antenna 411a and the second antenna 412a may be different from each other. For example, when the first antenna 411a and the third antenna 410 are misaligned, the second antenna 412a may be positioned to compensate for the angle of arrival and/or phase difference of arrival between the first antenna 411a and the third antenna 410.

According to an embodiment of the disclosure, when the first antenna 411a and the third antenna 410 are misaligned, the first antenna 411a and the second antenna 412a may be used to measure, for example, the angle of arrival of a polarized (e.g., horizontally polarized) signal received from an external electronic device (e.g., the external electronic device 102 or 104 in FIG. 1) in the horizontal direction (e.g., the −x and the x axes).

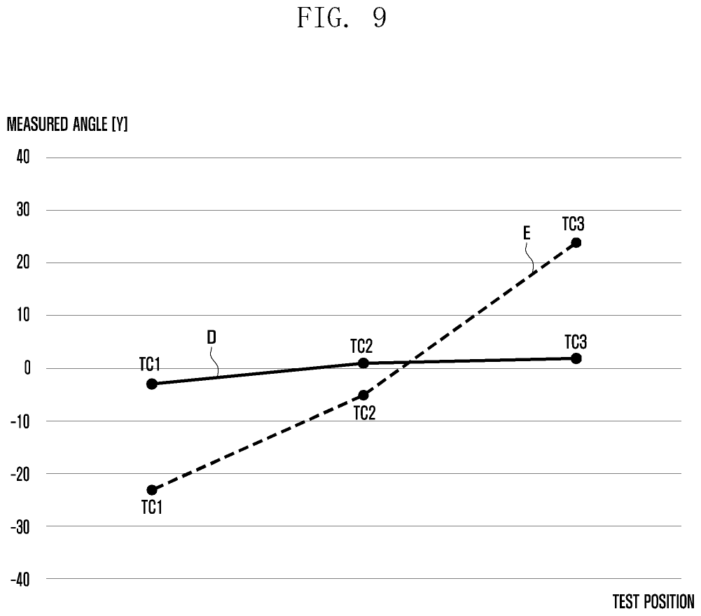

FIG. 9 schematically illustrates results of measuring a phase difference of arrival of an electronic device disclosed in FIG. 8 according to an embodiment of the disclosure.

Referring to FIG. 9, the x-axis may represent the test position, and the y-axis may represent the measurement angle. In an embodiment of the disclosure, graph D shown in FIG. 9 may be the phase difference of arrival (PDoA) measured using, for example, the first antenna 411a and the third antenna 410 disclosed in FIG. 8. In various embodiments of the disclosure, graph E shown in FIG. 9 may be, for example, the phase difference of arrival measured using the first antenna 411a and the second antenna 412a disclosed in FIG. 8.

According to an embodiment of the disclosure, a first test position TC1 shown in FIG. 9 may be a point between the x-axis and −y-axis directions of the electronic device 300 disclosed in FIG. 8, a second test position TC2 may be a point between the first antenna 411a and the third antenna 410 (e.g., a chip antenna) of the electronic device 300 disclosed in FIG. 8, and a third test position TC3 may be a point between the −x-axis and y-axis directions of the electronic device 300 disclosed in FIG. 8.

In an embodiment of the disclosure, referring to graph D shown in FIG. 9, when the first antenna 411a and the third antenna 410 are misaligned with respect to the −x-axis and x-axis directions, the phase differences of arrival at the first test position TC1, the second test position TC2 and the third test position TC3 can be observed to be similar at approximately 0 degrees. For example, when the first antenna 411a and the third antenna 410 are misaligned with respect to the −x-axis and x-axis directions, for example, by an angle L1 disclosed in FIG. 8, the phase differences of arrival at the first test position TC1, the second test position TC2, and the third test position TC3 may have similar values at approximately 0 degrees, as shown in graph D in FIG. 9.

In various embodiments of the disclosure, referring to graph E shown in FIG. 9, when the first antenna 411a and the second antenna 412a are substantially aligned with respect to the −x-axis and x-axis directions, the phase differences of arrival at the first test position TC1, the second test position TC2, and the third test position TC3 may be observed to differ between approximately +25 degrees and −25 degrees. For example, when the first antenna 411a and the second antenna 412a are misaligned with respect to the −x-axis and x-axis directions, for example, by an angle L2 disclosed in FIG. 8, the phase differences of arrival at the first test position TC1, the second test position TC2, and the third test position TC3 may have different values between approximately +25 degrees and −25 degrees, as shown in graph E in FIG. 9. Through this, the electronic device 300 may resolve problems caused by a phase difference of arrival that may arise when, for example, the first antenna 411a, the third antenna 410, and the second antenna 412a are misaligned. In an embodiment of the disclosure, the electronic device 300 may identify that the first test position TC1 and the third test position TC3 are not actual 0 degrees, but rather distorted 0 degrees.

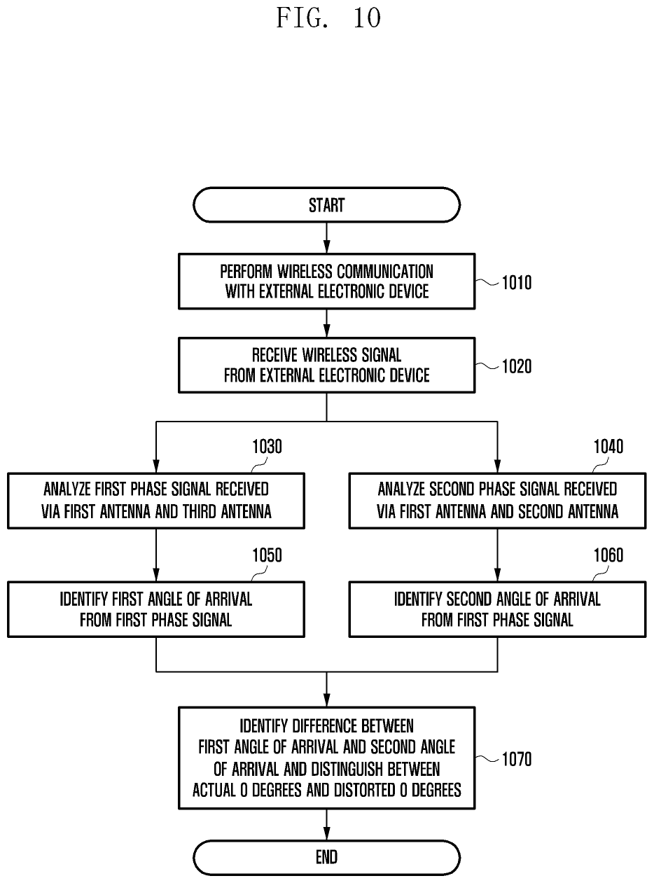

FIG. 10 is a flowchart illustrating a method for controlling an electronic device according to an embodiment of the disclosure.

According to an embodiment of the disclosure, the method disclosed below may be performed, for example, through the components of the electronic device 300 disclosed in FIG. 4A. The method disclosed below may include, for example, the embodiments disclosed in FIGS. 1, 2A, 2B, 3, 4A, 4B, 5, 6, 7, 8, and 9.

In the following embodiments of the disclosure, the operations may be performed sequentially, but need not necessarily be performed sequentially. For example, the order of the operations may be changed. For example, the operations may be performed in parallel. For example, not all operations may be performed, and at least some operations may be performed. The operations disclosed below may be performed, for example, by the processor 120 of the electronic device 300 disclosed in FIG. 4A.

In operation 1010, the electronic device 300 (e.g., the processor 120) may perform wireless communication with an external electronic device (e.g., the external electronic device 102 or 104 and/or the server 108 in FIG. 1).

According to an embodiment of the disclosure, the processor 120 may perform a Bluetooth low energy (BLE) scan operation to perform wireless communication with the external electronic device (e.g., the external electronic device 102 or 104 and/or the server 108 in FIG. 1). According to various embodiments of the disclosure, the processor 120 may measure the distance to the external electronic device (e.g., the external electronic device 102 or 104 and/or the server 108 in FIG. 1) by using double-sided two-way ranging (DS-TWR).

In operation 1020, the electronic device 300 (e.g., the processor 120) may receive a wireless signal from the external electronic device by using the first antenna 411a, the third antenna 410, and the second antenna 412a. In operation 1030, the electronic device 300 (e.g., the processor 120) may analyze a first phase signal received via the first antenna 411a and the third antenna 410.

According to an embodiment of the disclosure, the processor 120 may convert a phase difference of arrival based on the first phase signal received via the first antenna 411a and the third antenna 410 into a first angle of arrival (AOA).

In operation 1040, the electronic device 300 (e.g., the processor 120) may analyze a second phase signal received via the first antenna 411a and the second antenna 412a.

According to an embodiment of the disclosure, the processor 120 may convert a phase difference of arrival based on the second phase signal received via the first antenna 411a and the second antenna 412a into a second angle of arrival (AOA).

In operation 1050, the electronic device 300 (e.g., the processor 120) may identify the first angle of arrival (AOA) from the first phase signal received via the first antenna 411a and the third antenna 410.

In operation 1060, the electronic device 300 (e.g., the processor 120) may identify the second angle of arrival from the second phase signal received via the first antenna 411a and the second antenna 412a.

In operation 1070, the electronic device 300 (e.g., the processor 120) may identify the difference between the first angle of arrival and the second angle of arrival, and distinguish between actual 0 degrees and distorted 0 degrees.

According to an embodiment of the disclosure, when the difference between the first angle of arrival and the second angle of arrival is greater than or equal to a reference value, the electronic device 300 (e.g., the processor 120) may recognize the external electronic device positioned at the actual 0-degree location relative to the electronic device 300.

According to an embodiment of the disclosure, when the difference between the first angle of arrival and the second angle of arrival is less than the reference value, the electronic device 300 (e.g., the processor 120) may filter the distorted 0 degrees and recognize the external electronic device positioned at the actual 0-degree location relative to the electronic device 300.

According to an embodiment of the disclosure, the electronic device 300 (e.g., the processor 120) may identify the difference between the first angle of arrival and the second angle of arrival and identify the distortion characteristics between the first phase signal and the second phase signal.

According to an embodiment of the disclosure, the electronic device 300 (e.g., the processor 120) may identify and filter the distorted 0 degrees when the distortion characteristics between the first phase signal and the second phase signal do not satisfy a reference value.

According to an embodiment of the disclosure, the electronic device 300 (e.g., the processor 120) may recognize an external electronic device positioned at the actual 0-degree location when the distortion characteristics between the first phase signal and the second phase signal satisfy the reference value.

An electronic device 101, 200, or 300 according to an embodiment of the disclosure may include a side member 310 including a first side surface 301 having a first segment 401 and a second side surface 302 having a second segment 402, a first antenna 411a including a first conductive portion 411 at least partially included in the first side surface 301, a second antenna 412a including a second conductive portion 412 at least partially included in the second side surface 302, a printed circuit board 340 disposed inside the side member 310 and including a processor 120 and a wireless communication module 192, and a third antenna 410 disposed between the first antenna 411a and the second antenna 412a. According to an embodiment of the disclosure, the first antenna 411a and the second antenna 412a may be antennas of a first type, and the third antenna 410 may be an antenna of a second type. According to an embodiment of the disclosure, the processor 120 may be configured to receive a first phase signal from an external electronic device 102 or 104 by using the first antenna 411a and the third antenna 410, receive a second phase signal from the external electronic device 102 or 104 by using the first antenna 411a and the second antenna 412a, and based on the first phase signal and the second phase signal, identify a position of the external electronic device 102 or 104.

According to an embodiment of the disclosure, the first antenna 411a, the third antenna 410, and the second antenna 412a may be aligned in a substantially horizontal direction.

According to an embodiment of the disclosure, the first antenna 411a, the third antenna 410, and the second antenna 412a may be misaligned in the substantially horizontal direction.

According to an embodiment of the disclosure, the first antenna 411a and the third antenna 410 may be positioned within a distance of λ/2.

According to an embodiment of the disclosure, the first antenna 411a and the second antenna 412a are positioned at a distance of K*λ/2 or more, where K may not be an integer.

According to an embodiment of the disclosure, the first antenna 411a may be disposed closer to the third antenna 410 than to the second antenna 412a.

According to an embodiment of the disclosure, a distance between the first antenna 411a and the third antenna 410 may be shorter than a distance between the first antenna 411a and the second antenna 412a.

According to an embodiment of the disclosure, a diplexer 450 may be disposed between the first antenna 411a and the wireless communication module 192.

According to an embodiment of the disclosure, the first conductive portion 411 may include a first point P1, a second point P2, and a first feed point F1 located between the first point P1 and the second point P2, and the first feed point F1 may be electrically connected to the wireless communication module 192 via a first signal path S1.

According to an embodiment of the disclosure, the printed circuit board 340 may include a first ground point G1 and a second ground point G2, the first point P1 may be electrically connected to the first ground point G1 via a first ground path GL1, and the second point P2 may be electrically connected to the second ground point G2 via a second ground path GL2.

According to an embodiment of the disclosure, the first antenna 411a may be configured to operate as a first slot antenna by using the first ground point G1, the first point P1, the second point P2, and the second ground point G2.

According to an embodiment of the disclosure, the second conductive portion 412 may include a third point P3, a fourth point P4, and a second feed point F2 located between the third point P3 and the fourth point P4, and the second feed point F2 may be electrically connected to the wireless communication module 192 via a second signal path S2.

According to an embodiment of the disclosure, the printed circuit board 340 may include a third ground point G3 and a fourth ground point G4, the third point P3 may be electrically connected to the third ground point G3 via a third ground path GL3, and the fourth point P4 may be electrically connected to the fourth ground point G4 via a fourth ground path GL4.

According to an embodiment of the disclosure, the second antenna 412a may be configured to operate as a second slot antenna by using the third ground point G3, the third point P3, the fourth point P4, and the fourth ground point G4.

According to an embodiment of the disclosure, the third antenna 410 may include a feed point PF electrically connected to the wireless communication module 192 via a third signal path S3.

According to an embodiment of the disclosure, the first antenna 411a, the third antenna 410, and the second antenna 412a may be configured to have feeding directions formed in a substantially horizontal direction.

According to an embodiment of the disclosure, the first antenna 411a and the third antenna 410 may be configured to have feeding directions formed in a first direction, and the second antenna 412a may be configured to have a feeding direction formed in a second direction opposite to the first direction.

According to an embodiment of the disclosure, each of the first antenna 411a and the second antenna 412a may be configured to operate as an inverted-F antenna (IFA) or a monopole antenna.

According to an embodiment of the disclosure, the third antenna 410 may include a patch antenna or a chip antenna.

According to an embodiment of the disclosure, the processor 120 may be configured to analyze the first phase signal received via the first antenna 411a and the third antenna 410, analyze the second phase signal received via the first antenna 411a and the second antenna 412a, identify a first angle of arrival from the first phase signal, identify a second angle of arrival from the second phase signal, and identify a difference between the first angle of arrival and the second angle of arrival.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a side member comprising a first side surface having a first segment and a second side surface having a second segment;
a first antenna comprising a first conductive portion at least partially included in the first side surface;
a second antenna comprising a second conductive portion at least partially included in the second side surface;
a printed circuit board disposed inside the side member and comprising at least one processor and a wireless communication module;
a third antenna disposed between the first antenna and the second antenna; and
memory, comprising one or more storage media, storing instructions,
wherein the at least one processor is communicatively coupled to the memory and the wireless communication module,
wherein the first antenna and the second antenna are antennas of a first type, and the third antenna is an antenna of a second type, and
wherein the instructions when executed by the at least one processor individually or collectively, cause the electronic device to:
receive a first phase signal from an external electronic device by using the first antenna and the third antenna,
receive a second phase signal from the external electronic device by using the first antenna and the second antenna, and
based on the first phase signal and the second phase signal, identify a position of the external electronic device.

2. The electronic device of claim 1, wherein the first antenna, the third antenna, and the second antenna are aligned in a horizontal direction.

3. The electronic device of claim 2, wherein the first antenna, the third antenna, and the second antenna are misaligned in the horizontal direction.

4. The electronic device of claim 1, wherein the first antenna and the third antenna are positioned within a distance of λ/2.

5. The electronic device of claim 1, wherein the first antenna and the second antenna are positioned at a distance of K*λ/2 or more, where K is not an integer.

6. The electronic device of claim 1, wherein the first antenna is disposed closer to the third antenna than to the second antenna.

7. The electronic device of claim 1, wherein a distance between the first antenna and the third antenna is shorter than a distance between the first antenna and the second antenna.

8. The electronic device of claim 1, wherein a diplexer is disposed between the first antenna and the wireless communication module.

9. The electronic device of claim 1,
wherein the first conductive portion comprises a first point (P1), a second point (P2), and a first feed point (F1) located between the first point (P1) and the second point (P2),
wherein the first feed point (F1) is electrically connected to the wireless communication module via a first signal path (S1),
wherein the second conductive portion comprises a third point (P3), a fourth point (P4), and a second feed point (F2) located between the third point (P3) and the fourth point (P4), and
wherein the second feed point (F2) is electrically connected to the wireless communication module via a second signal path (S2).

10. The electronic device of claim 9,
wherein the printed circuit board comprises a first ground point (G1) and a second ground point (G2),
wherein the first point (P1) is electrically connected to the first ground point (G1) via a first ground path (GL1), and the second point (P2) is electrically connected to the second ground point (G2) via a second ground path (GL2), and
wherein the first antenna is configured to operate as a first slot antenna by using the first ground point (G1), the first point (P1), the second point (P2), and the second ground point (G2).

11. The electronic device of claim 9,
wherein the printed circuit board comprises a third ground point (G3) and a fourth ground point (G4),
wherein the third point (P3) is electrically connected to the third ground point (G3) via a third ground path (GL3), and the fourth point (P4) is electrically connected to the fourth ground point (G4) via a fourth ground path (GL4), and
wherein the second antenna (412a) is configured to operate as a second slot antenna by using the third ground point (G3), the third point (P3), the fourth point (P4), and the fourth ground point (G4).

12. The electronic device of claim 1, wherein the third antenna comprises a feed point (PF) electrically connected to the wireless communication module via a third signal path (S3).

13. The electronic device of claim 1,
wherein the first antenna and the third antenna are configured such that feeding directions thereof are formed in a first direction,
wherein the second antenna is configured such that a feeding direction thereof is formed in a second direction opposite to the first direction, and
wherein each of the first antenna and the second antenna is configured to operate as an inverted-F antenna (IFA) or a monopole antenna.

14. The electronic device of claim 1, wherein the third antenna comprises a patch antenna or a chip antenna.

15. The electronic device of claim 1, wherein the instructions, when executed by the at least one processor individually or collectively, further cause the electronic device to:
analyze the first phase signal received via the first antenna and the third antenna,
analyze the second phase signal received via the first antenna and the second antenna,
identify a first angle of arrival from the first phase signal,
identify a second angle of arrival from the second phase signal, and
identify a difference between the first angle of arrival and the second angle of arrival.
